(19) United States
(12) Patent Application Publication
(10) Pub. No.: US 2005/0081626 A1
(43) Pub. Date: Apr. 21, 2005

(54) METHOD FOR DETECTING AN UNBALANCED DISC

(76) Inventors: Feng-Fu Lin, Taipei City (TW); Tung-Hsu Hsieh, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,401

(22) Filed: Mar. 1, 2004

(30) Foreign Application Priority Data
Oct. 15, 2003 (TW) 092128618

(51) Int. Cl. G11B 23/00; G01M 1/16

(52) U.S. Cl. 73/460

(57) ABSTRACT

A CD drive has a pick-up head for reading data of an optical disc, and a motor for rotating the optical disc. The method first adjusts the rotary speed of the motor so that the vibration frequency of the CD drive is approximately the resonance frequency of a coil of the pick-up head. Then, when the vibration frequency of the CD drive is approximately the resonance frequency of the coil of the pick-up head, the method detects if the voltage of a central error (CE) signal of the CD drive is greater than a threshold voltage. Finally, the method determines if the optical disc is an unbalanced disc according to the comparison result.

### BACKGROUND OF INVENTION

1. Field of the Invention

The present invention relates to a method for detecting an unbalanced disc by means of a compact disc (CD) drive, and more particularly, to a method that detects a central error (CE) signal of the CD drive when the vibration frequency is approximately a resonance frequency of a coil of a pick-up head of the CD drive so as to detect the unbalanced disc when the CD drive operates at low rotary speed.

2. Description of the Prior Art

As technologies of manufacturing optical storage devices improve, both the reading speed and writing speed of CD drives have made impressive progress. Since the high reading and writing speed performance of CD drive requires a high rotary speed motor, the vibration of the CD drive inevitably becomes acute while the rotary speed of the motor increases. Also, the mechanical limitations of the CD drive tend to generate resonance between the pick-up head and the motor, thereby deteriorating the performance of the CD drive. In addition, an optical disc of poor quality influences performance of the CD drive as well. Normally, optical discs of poor quality are classified into two kinds: unbalanced discs and vertical discs. Unbalanced discs have an unequally coated pigment thereon, and therefore the weight distribution of the unbalanced disc is not even. Vertical discs are warped due to unequal injection when such discs are fabricated.

An unbalanced disc is similar to a car that has four unbalanced tires. This car may go smoothly in low speed. While the speed gets higher, however, the car begins to vibrate. Similarly, an unbalanced disc vibrates strongly at high rotary speed. The vibration of the unbalanced disc seriously affects performance of the CD drive. In a worse situation, the vibration causes a permanent damage to the bearing of the motor.

When a CD drive reads an optical disc, a focus error (FE) signal and a track error (TE) signal are frequently used to adjust the position of the pick-up head so as to correctly read or write data on the optical disc. The focus error signal represents the accuracy of the laser beam that is emitted from the pick-up head and focused onto the optical disc, while the track error signal indicates whether the laser beam can precisely orient tracks of the optical disc.

Conventionally, the method of detecting an unbalanced optical disc is to input the FE signal or TE signal through a bandpass filter, and then to compare the output FE signal or TE signal with a predetermined threshold voltage. If the FE signal or TE signal is larger than the threshold voltage, the optical disc is determined as an unbalanced optical disc. However, the conventional method is practicable only when the rotary speed of the CD drive is high. As long as the optical disc is considered as an unbalanced optical disc, the rotary speed is lowered so as to correctly read data of the optical disc. In addition, the conventional method fails to distinguish an unbalanced disc from a vertical disc. This further inhibits a CD drive to correctly read data of an optical disc.

Consequently, if an unbalanced disc can be detected at low rotary speed, it becomes easier to improve the reading efficiency of the CD drive and to overcome the control difficulty of the CD drive.

### SUMMARY OF INVENTION

It is therefore a primary objective of the claimed invention to provide a method of detecting an unbalanced disc for overcoming the above problems.

According to the claimed invention, a method for detecting an unbalanced disc by means of a CD drive is disclosed. The CD drive includes a pick-up head for reading data of an optical disc, and a motor for rotating the optical disc. The method comprises the following steps:
(a) adjusting a rotary speed of the motor so that a vibration frequency of the CD drive is approximately a resonance frequency of a coil of the pick-up head;
(b) when the vibration frequency of the CD drive is approximately the resonance frequency of the coil of the pick-up head, detecting if a voltage value of a central error (CE) signal is larger than a threshold voltage; and
(c) determining if the optical disc is an unbalanced disc according to a result of step (b).

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a CD drive of the present invention.

FIG. 2 to FIG. 4 are schematic diagrams illustrating how the central error signal is received.

FIG. 5 is a flowchart illustrating the method for detecting an unbalanced disc according to the present invention.

### DETAILED DESCRIPTION

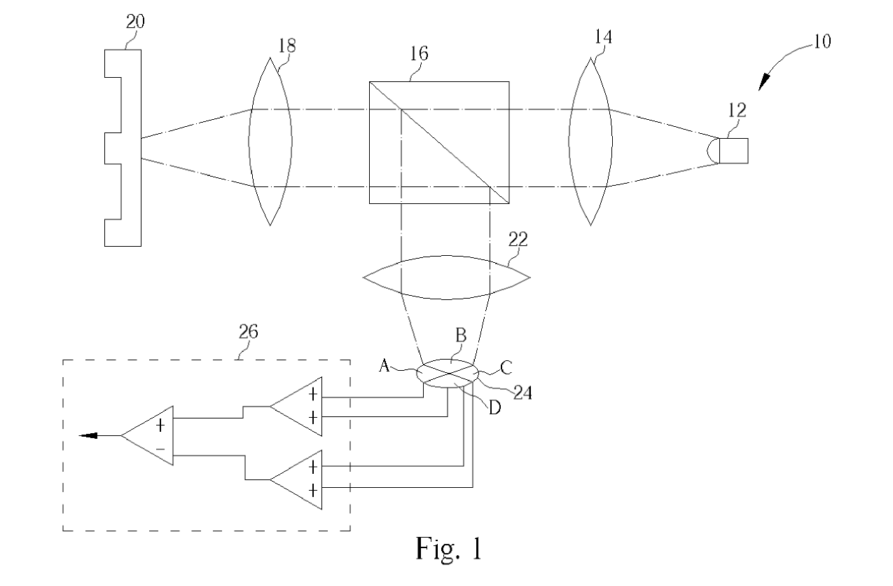

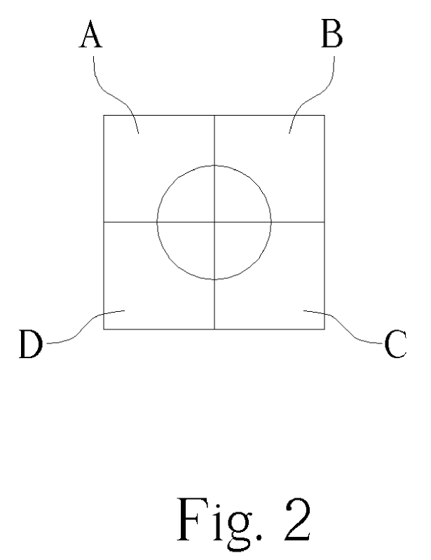

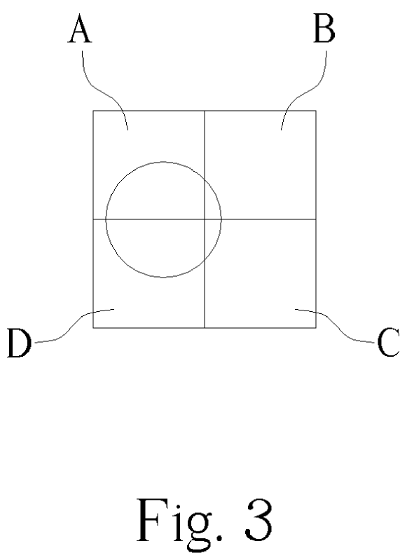

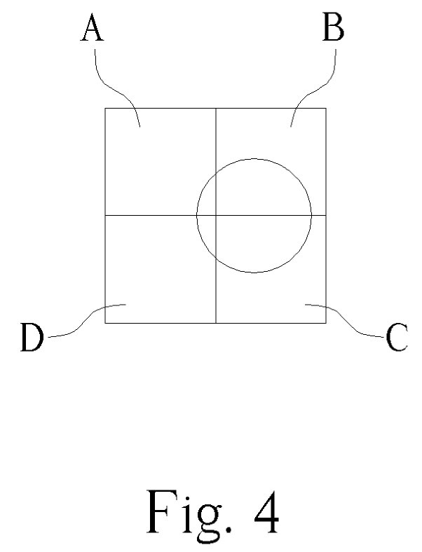

Please refer to FIG. 1 to FIG. 4. FIG. 1 is a schematic diagram of a CD drive 10 of the present invention; FIG. 2 to FIG. 4 are schematic diagrams illustrating how the central error signal is received. The CD drive 10 includes a pick-up head 12, a first lens 14, a spectroscope 16, an object lens 18, a second lens 22, and a photoelectric sensor 24. The pick-up head 12 emits a laser beam. The laser beam is equalized by the first lens 14, passed through the spectroscope 16, and sent to the object lens 18 so as to focus on an optical disc 20. Accordingly, the laser beam is reflected by the optical disc 22, passes through the spectroscope 16, and arrives at the photoelectric sensor 24. Therefore, the reflected laser beam is received by the photoelectric sensor 24 and converted into a voltage signal. The photoelectric sensor 24 is connected to different control circuits for the purpose of generating different voltage signals, such as a FE signal or a TE signal. According to the present invention, the photoelectric sensor 24 is connected to a control circuit 26 for generating a central error (CE) signal. As shown in FIG. 2 to FIG. 4, the illuminated face of the photoelectric sensor 24 is clockwise divided into four areas A, B, C, and D. The CE signal is the intensity difference between the left half region and the right half region of the photoelectric sensor 24. Therefore, the CE signal can be briefly described by the following equation CE=k[(A+D)−(B+C)], where k is a coefficient. Therefore, by calculating the CE signal the deviation of the pick-up head 12 relative to the central position of the optical disc is perceived when reading the optical disc 20. In a normal condition, the reflected laser beam is supposed to be located in the central position of the photoelectric sensor 24, as shown in FIG. 2. However, if the reflected laser beam approaches the central position of the optical disc 20, the left half region (areas A and D) will receive more reflected laser beam as shown in FIG. 3. According to the definition of CE, a larger voltage signal will be generated. On the other hand, if the laser beam reflects away from the central position of the optical disc 20, the right half region (areas B and C) will receive more reflected laser beam as shown in FIG. 4. Similarly, a larger voltage signal will be generated in this case.

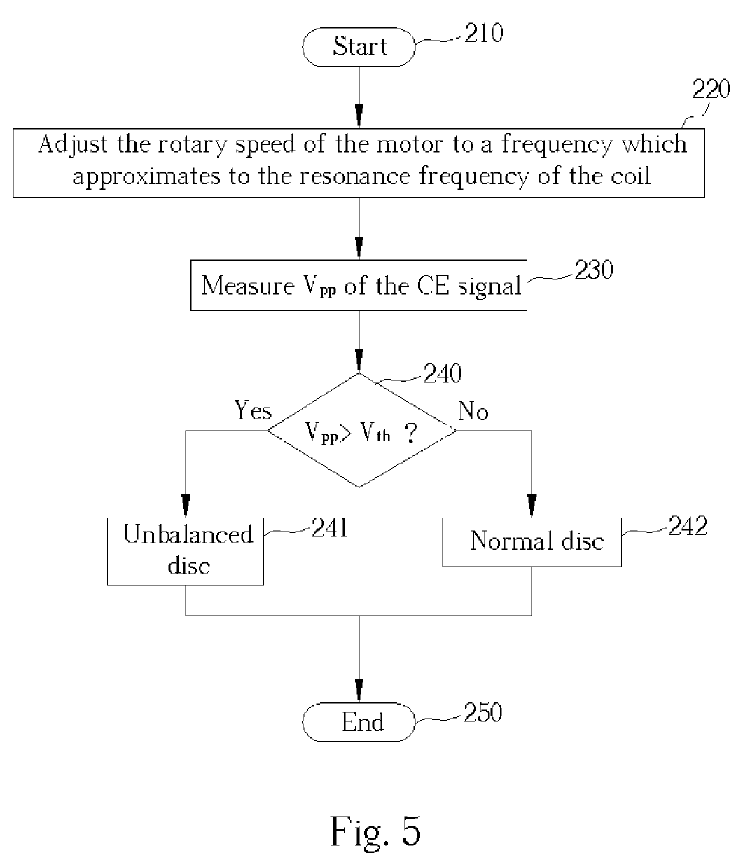

Please refer to FIG. 5. FIG. 5 is a flowchart illustrating the method for detecting an unbalanced disc according to the present invention. The CD drive 10 controls the pick-up head 12 via a coil, and the vibration of the CD drive 10 leads to a resonance of the coil. If the vibration frequency of the coil is less than the first resonance frequency, the vibration breadth of the pick-up head 12 will augment as the vibration frequency of the coil increases. Since the pick-up head 12 is a part of the CD drive 10, the vibration breadth of CD drive 10 is proportional to that of the pickup head 12. While the vibration frequency of the coil equals the first resonance frequency, the vibration breadth of the pick-up head 12 will reach its maximum. Nevertheless, while the vibration frequency of the coil exceeds the first resonance frequency, the vibration breadth of the pick-up head 12 will diminish as the vibration frequency of the coil increases. Presently, the vibration breadth of the CD drive 10 can be maintained in a steady state in a certain frequency range. Normally, the first resonance frequency of the coil is located in this range where the vibration breadth of the CD drive 10 remains steady. On the basis of this character, the CD drive 10 reads the optical disc 20 at a frequency which approximates the first resonance frequency of the coil. In such case, the CE signal of an unbalanced disc is obviously larger than that of a normal disc.

The method for detecting an unbalanced disc includes the following steps:
Step 210: start detecting the optical disc 20;
Step 220: adjust the rotary speed of the motor to a frequency which is approximately the first resonance frequency of the coil of the pick-up head 12, so that the vibration frequency of the CD drive 10 is approximately the first resonance frequency of the coil of the pick-up head 12;
Step 230: measure the voltage value of the CE signal Vₚₚ;
Step 240: determine if Vₚₚ is larger than a predetermined threshold voltage Vₜₕ, if yes, then execute step 241, otherwise, execute step 242;
Step 241: determine the optical disc 20 as an unbalanced disc;
Step 242: determine the optical disc 20 as a normal disc;
Step 250: end.

An illustrative example is listed as follows to show how to detect an unbalanced disc according to the present invention. Assume the vibration breadth of the CD drive 10 can be maintained between 20 Hz and 150 Hz while the vibration frequency increases, and the first resonance frequency of the coil of the pick-up head 12 is approximately 40 Hz. While the rotary speed of the motor of the CD drive 10 reaches 2400 rpm, the vibration frequency of the CD drive 10 will become approximately the first resonance frequency of the coil. In such case, since the rotary speed of the motor is not very high, the CD drive 10 is able to determine if the optical disc 20 is an unbalanced disc or not according to the voltage value of the CE signal Vₚₚ. Substantially, the CE signal of a normal disc is 400 mv, while the CE signal of an unbalanced reaches 1500 mv in most cases. Once the optical disc 20 is marked as an unbalanced disc, a different method is adopted to read the optical disc 20 so as to improve the efficiency of the CD drive 20. It is to be noted that the CE signal is selected, instead of the TE signal, because the error range of CE signal is much greater than that of TE signal.

Briefly described, while the CD drive 10 reads an unbalanced disc and a normal disc in the first resonance frequency of the coil of the pick-up head 12, the CE signals of the unbalanced disc and the normal disc are remarkably different. Therefore, according to the present invention, the rotary speed of the motor is adjusted to a low speed so that the vibration frequency of the CD drive 10 is approximately the first resonance frequency of the coil of the pick-up head 12. Then the CE signal is detected, and if the CE signal is greater than a predetermined threshold value, the optical disc 20 is determined as an unbalanced disc. In such case, the CD drive 10 can adopt a different method for improving the efficiency of reading the optical disc 20.

In comparison with the prior art, an unbalanced disc can be detected when the rotary speed of the CD drive is low. Thus, it becomes easier to improve the reading efficiency of the CD drive and to overcome control difficulties of the CD drive. In addition, vertical discs can be detected in the art when the rotary speed is low, thus the method of the present invention is able to distinguish unbalanced discs from vertical discs at low rotary speed.

Those skilled in the art will readily appreciate that numerous modifications and alterations of the device may be made without departing from the scope of the present invention. Accordingly, the above disclosure should be construed as limited only by the metes and bounds of the appended claims.

1. A method for detecting an unbalanced disc with a compact disc (CD) drive, the CD drive comprising a pickup head for reading data stored on an optical disc, and a motor for rotating the optical disc, the method comprising the following steps:
(a) adjusting a rotary speed of the motor so that a vibration frequency of the CD drive is approximately a resonance frequency of a coil of the pick-up head;
(b) when the vibration frequency of the CD drive is approximately the resonance frequency of the coil of the pick-up head, detecting if a voltage value of a central error (CE) signal is larger than a threshold voltage; and
(c) determining if the optical disc is an unbalanced disc according to a result of step (b).

2. The method of claim 1 wherein the method further comprises converting an optical signal, which is reflected from the optical disc and received by the pick-up head, into the voltage value.

3. The method of claim 2 wherein the CE signal is generated according to the optical signal that is reflected from the optical disc and received by the pick-up head.

4. The method of claim 1 wherein when the voltage value of the CE signal is larger than the threshold voltage, the optical disc is determined as an unbalanced disc.

5. A device for implementing the method of claim 1.
